(19) United States
(12) Patent Application Publication
(10) Pub. No.: US 2008/0133450 A1
(43) Pub. Date: Jun. 5, 2008

(54) Structured Document Retrieval Device, Structured Document Retrieval Method Structured Document Retrieval Program

(75) Inventors: Keiichi Iguchi, Tokyo (JP); Kazuya Koyama, Tokyo (JP)

Correspondence Address: YOUNG & THOMPSON, 209 Madison Street, Suite 500, ALEXANDRIA, VA, 22314, US

(73) Assignee: NEC CORPORATION, TOKYO (JP)

(21) Appl. No.: 11/795,979

(22) PCT Filed: Jan. 23, 2006
(86) PCT No.: PCT/JP2006/301373

§ 371 Date: Jul. 25, 2007

(30) Foreign Application Priority Data
Jan. 25, 2005 (JP) 2005-017331

(51) Int. Cl. G06F 17/30

(52) U.S. Cl. 707/1; 707/E17.008

(57) ABSTRACT

In the structured document retrieval device, a condition in which an element designated by a retrieval expression fails to occur is obtained from structure information and added as an interruption condition to a retrieval automaton and when the interruption condition is satisfied, a state transition of the retrieval automaton is deleted and when there remains none of all the effective state transitions, determination is made that the designated element will no more appear even by further analysis to end the analysis of a structured document. Without retrieving the structured document to the end, the element designated by the retrieval expression can be extracted without overs and shorts.

### TECHNICAL FIELD

The present invention relates to a structured document retrieval device, a structured document retrieval method and a program for retrieval of structured document and, more specifically, a structured document retrieval device, a structured document retrieval method and a structured document retrieval program for retrieving and extracting a specific element of a structured document by using a retrieval expression.

### BACKGROUND ART

Used as a retrieval expression for extracting a specific element in an XML document as a structured document is XPath (XML Path Language). XPath is standardized by standardization organization W3C (WWW consortium), whose specification is recited in Literature 1 (┌XML Path Language (XPath)┘, [online], [retrieved on Dec. 22, 2004], Internet, <URL:http://www.w3.org/TR/xpath>).

In XPath, an XML element is segmented by “/” and enumerated to designate a specific element in a structure. At the time of retrieving an element designated by XPath from an XML document, it is a related practice to execute retrieval after once expanding the XML document into DOM (Document Object Model) format in a storage region. Load on processing for expanding an XML document into DOM format, however, is heavy and requires a large storage region, so that XPath retrieval is processing with heavy load.

Techniques for solving the problem by sequentially analyzing an XML document without expanding the document into DOM by the use of a SAX (Simple API for XML) parser to extract an element matching XPath are recited in Japanese Patent Laying-Open No. 2003-323429 and Literature 2 (“Mehmet Altinel, Michael Franklin: Efficient Filtering of XML Documents for Selective Dissemination of Information, Very Large Data Base Endowment, 2000, pp. 53-64”).

Such a structured document retrieval device 800, as shown in FIG. 11, comprises a structured document analysis unit 810, a retrieval expression analysis unit 820, a retrieval automaton management unit 840 and a storage device 850.

FIG. 12 is a flow chart showing operation of the structured document retrieval device 800 illustrated in FIG. 11. When a retrieval expression is input to the retrieval expression analysis unit 820, analysis of the retrieval expression is made to transfer an analysis result to the retrieval automaton management unit 840 (Step S110). Upon receiving the analysis result of the retrieval expression, the retrieval automaton management unit 840 creates a retrieval automaton 851 and records the same in the storage device 850 (Step S830). FIG. 13 shows an example of the retrieval automaton 851 created. When an XPath expression 510 as an example of a retrieval expression shown in FIG. 14 is input, the retrieval automaton 851 is created. The retrieval automaton 851 includes four states 911, 912, 913 and 914, with the state 914 as an end state. Also included are states of transition between the respective states, 921, 922 and 923, in which an event necessary for a state transition is recited.

Subsequently, when a structured document (e.g. an XML document in a received message) is input to the structured document analysis unit 810 (Step S140), the structured document analysis unit 810 sequentially analyzes the structured document to transfer an analysis result to the retrieval automaton management unit 840 (Step S150). Analysis of the structured document is made on a part basis (e.g. element) and transferred to the retrieval automaton management unit 840 every time analysis is made.

When accepting transfer of the analysis result of the structured document, the retrieval automaton management unit 840 executes retrieval automaton processing (Step S870). FIG. 15 is a flow chart showing processing executed at Step S870. The retrieval automaton management unit 840 checks whether an event of the transferred analysis result relates to an element to be a target of a state transition or not and when it is not a target of a state transition, ends the retrieval automaton processing (Step S171).

Subsequently, determine whether a kind of the event of the analysis result is an event indicative of the start of an element or an event indicative of the end of the element (Step S172) and when it is an event indicative of the end of the element, make a reverse transition of the state of the automaton 151 to a state as of before the transition and record the state in the storage device 150 (Step S178). As a result of Step S172, when it is an event indicative of the start of the element, make a state transition according to the retrieval automaton 851 and record a current state in the storage device 850 (Step S173). As a result of the state transition, when the state of the retrieval automaton 851 reaches the end state (Step S174), determine that the retrieval expression is satisfied to output a result (Step S175).

Repeat the processing of Step S150 through Step 870 until processing of the entire structured document is completed (Step S160).

Problem of a structured document retrieval system in the related art is the need of retrieving a structured document to the end in order to obtain elements matching a retrieval expression without overs and shorts. The reason is that since a related system is mainly directed to a document in which objective elements exist evenly, it fails to hold information about where objective elements exist in a structured document. In such a case where it is known that an element to be extracted appears in the first half of a structured document as extraction of identification information from a communication document, useless analysis processing might cause reduction of system execution performance.

### SUMMARY

An exemplary object of the invention is to provide a structured document retrieval system that can obtain an element matching a retrieval expression without overs and shorts only by analyzing a necessary part of a structured document, thereby improving processing efficiency.

A structured document retrieval device according to the present invention includes a structured document analysis unit for sequentially analyzing a structured document and a structure information analysis unit for analyzing structure information and at a stage of finding that an objective element will appear no more, interrupting analysis of a structured document.

### BRIEF DESCRIPTION OF THE DRAWINGS

FIG. 1 is a block diagram of an example of a structure of a structured document retrieval device according to a first exemplary embodiment of the invention;

FIG. 2 is a flow chart showing operation of the structured document retrieval device according to the first exemplary embodiment of the invention;

FIG. 3 is a flow chart showing operation of retrieval automaton processing according to the first exemplary embodiment of the invention;

FIG. 4 is a block diagram showing an example of a structure of a structured document retrieval device according to a second exemplary embodiment of the invention;

FIG. 5 is a block diagram showing an example of a structure including a structured document retrieval program for use in executing structured document retrieval;

FIG. 6 is a block diagram showing an XPath retrieval device according to an exemplary embodiment of the present invention;

FIG. 7 is an explanatory diagram showing an example of XML Schema;

FIG. 8 is an explanatory diagram showing an example of a retrieval automaton according to the exemplary embodiment of the present invention;

FIG. 9 is an explanatory diagram showing an example of an XML document;

FIG. 10 is an explanatory diagram showing an example of an event string generated from an SAX parser;

FIG. 11 is a block diagram showing one example of a structured document retrieval device in the related art;

FIG. 12 is a flow chart showing operation of the structured document retrieval device in the related art;

FIG. 13 is a block diagram showing an example of a retrieval automaton in the structured document retrieval device in the related art;

FIG. 14 is an explanatory diagram showing an example of an XPath expression; and

FIG. 15 is a flow chart showing operation of retrieval automaton processing in the structured document retrieval device in the related art.

### EXEMPLARY EMBODIMENT

Next, exemplary embodiments of the invention will be described in detail with reference to the drawings.

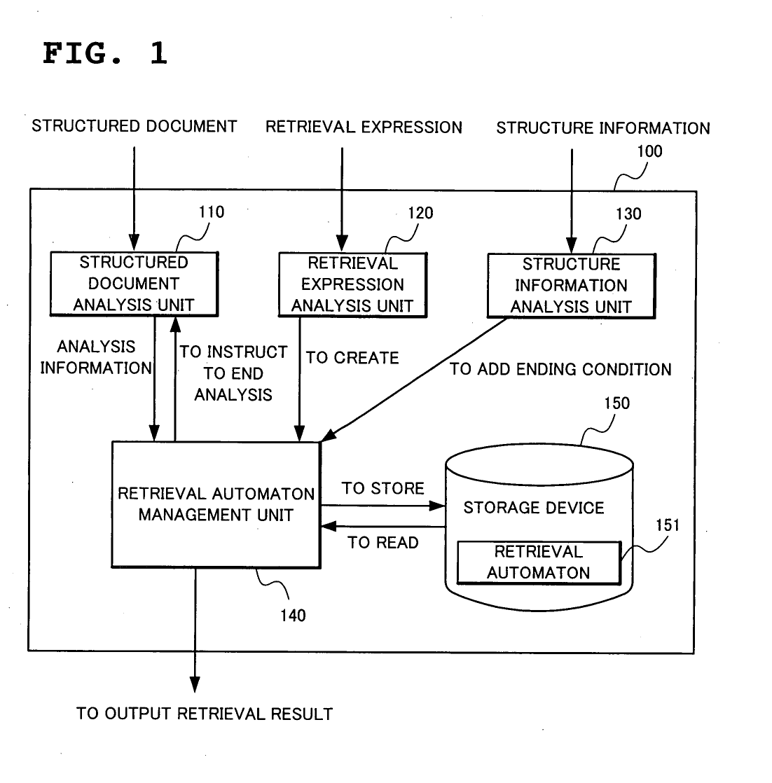

FIG. 1 is a block diagram showing an example of a structure of a structured document retrieval device 100 according to a first exemplary embodiment of the present invention. As shown in FIG. 1, the structured document retrieval device 100 includes a structured document analysis unit 110, a retrieval expression analysis unit 120, a structure information analysis unit 130, a retrieval automaton management unit 140 and a storage device 150.

The structured document analysis unit 110 analyzes a structured document input from such an input device as an input apparatus or a network interface or such a storage device as a RAM or a hard disk to sequentially transfer an analysis result to the retrieval automaton management unit 140 as a retrieval processing unit. The retrieval expression analysis unit 120 has a function of analyzing a retrieval expression input from the input device or the storage device. The retrieval expression analysis unit 120 analyzes an input retrieval expression to transfer an analysis result to the retrieval automaton management unit 140. The structure information analysis unit 130 has a function of analyzing structure information input from the input device or the storage device. The structure information analysis unit 130 analyzes input structure information to transfer an analysis result to the retrieval automaton management unit 140. The retrieval automaton management unit 140 has a function of creating a retrieval automaton 151 and a retrieval automaton state transition function.

The retrieval automaton management unit 140 creates the retrieval automaton 151 based on an analysis result of a retrieval expression transferred from the retrieval expression analysis unit 120 and an analysis result of structure information transferred from the structure information analysis unit 130 and records the same in the storage device 150. Recorded in the created retrieval automaton 151 is, as an interruption condition, a condition in which an element causing each state transition will fail to occur based on structure information obtained from the structure information analysis unit 130.

The Structure information is information including, related to an element forming a structured document, an inclusive relationship between elements and including either one or both of constraints on an element occurrence sequence and on the number of occurrences.

As a preferable example of an interruption condition, information about the maximum number of occurrences of an element can be used. Information about the sequence of occurrence of elements can be also used. In a case where an occurrence sequence of elements is recited in structure information, since when an element which is to occur only after last occurrence of an element causing a state transition occurs, the determination can be made that the element causing a state transition will occur no more, information about the occurrence sequence of elements can be used as an interruption condition. In a case where a structured document is XML as a preferable example, XML Schema can be used as a preferable example of structure information. DTD (Document Type Definition) can be also used. RELAX NG can be used as well. In a case of XML Schema, for example, usable as an interruption condition is the maximum number of occurrences of an element which is indicated as maxOccur and also usable is the occurrence sequence of elements which is indicated as sequence.

The retrieval automaton management unit 140 also causes a state of the retrieval automaton 151 recorded in the storage device 150 to transit based on a sequential analysis result of a structured document obtained from the structured document analysis unit 110. In addition, the unit deletes a state transition matching the interruption condition added to the retrieval automaton 151 from the retrieval automaton 151. As a result of deletion of a state transition, when there no more exists an effective state transition in the retrieval automaton 151, the unit determines that an element matching the retrieval expression will no more appear even by subsequent analysis to instruct the structured document analysis unit 110 to end the analysis. Furthermore, when the retrieval automaton 151 teaches the end state, the unit determines that the state matches the retrieval expression to output a result.

Stored in the storage device 150, which is formed by a storage medium such as a RAM, are various kinds of information of the retrieval automaton 151 and the like.

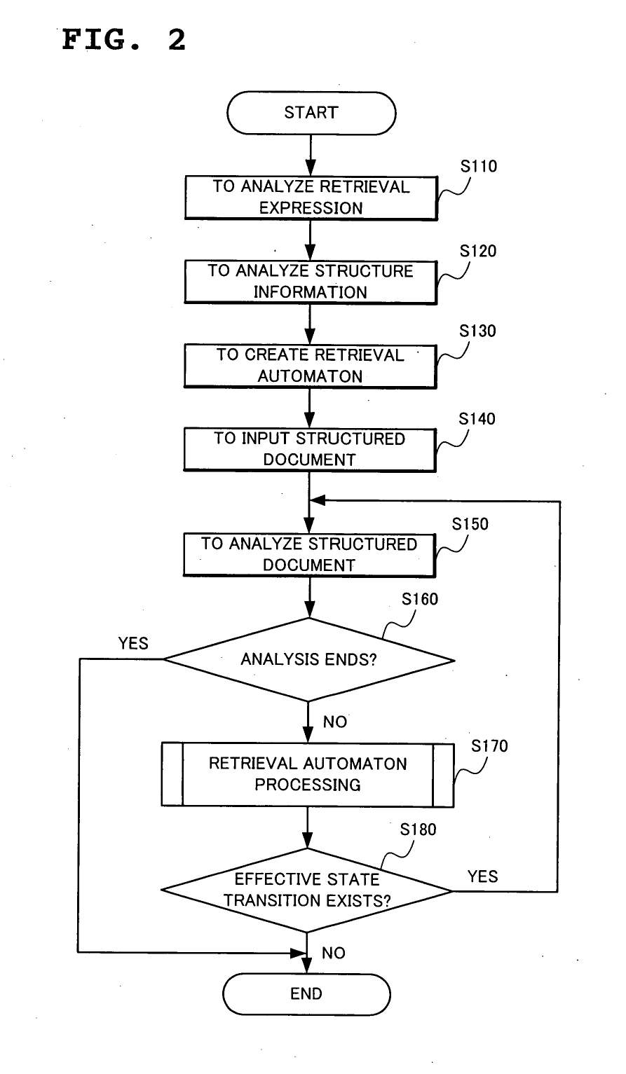

Next, entire operation of the first exemplary embodiment of the invention will be described in detail with reference to the block diagram of FIG. 1 and the flow chart of FIG. 2. FIG. 2 is a flow chart showing an example of structured document retrieval executed by the structured document retrieval device 100.

When a retrieval expression is input, the retrieval expression analysis unit 120 executes analysis of the retrieval expression to transfer an analysis result to the retrieval automaton management unit 140 (Step S110). As a preferable example of a retrieval expression, XPath can be used. XPoint (XML Pointer) can be used as well.

Next, when structure information is input, the structure information analysis unit 130 analyzes the structure information to transfer an analysis result to the retrieval automaton management unit 140 (Step S120). The order of execution of Step S110 and Step S120 is reversible. Upon receiving the analysis result of the retrieval expression and the retrieval result of the structure information, the retrieval automaton management unit 140 creates the retrieval automaton 151 and records the same in the storage device 150 (Step S130).

Subsequently, when a structured document is input to the structured document analysis unit 110 (Step S140), the structured document analysis unit 110 sequentially analyzes the structured document to transfer an analysis result to the retrieval automaton management unit 140 (Step S150). The structured document analysis unit 110 executes analysis of the structured document on a part basis and transfers an analysis result to the retrieval automaton management unit 140 every time analysis is made.

In a case, for example, where a structured document is XML as an preferable example, it is preferable to execute analysis for each tag. As a manner of transfer of such an analysis result, the SAX format can be used, for example. Also usable is Pull type analysis such as StAX.

SAX format is developed as a standard interface for event-based XML analysis, whose installation manual is recited in the Internet <http://java.sun.com/j2se/1.4/ja/docs/ja/api/org/xml/sax/package-summary.html>. StAX is an interface for sequentially reading and analyzing only necessary parts of XML on a document basis, whose specification requirement is recited in the Internet <http://jcp.org/en/jsr/detail?id=173>.

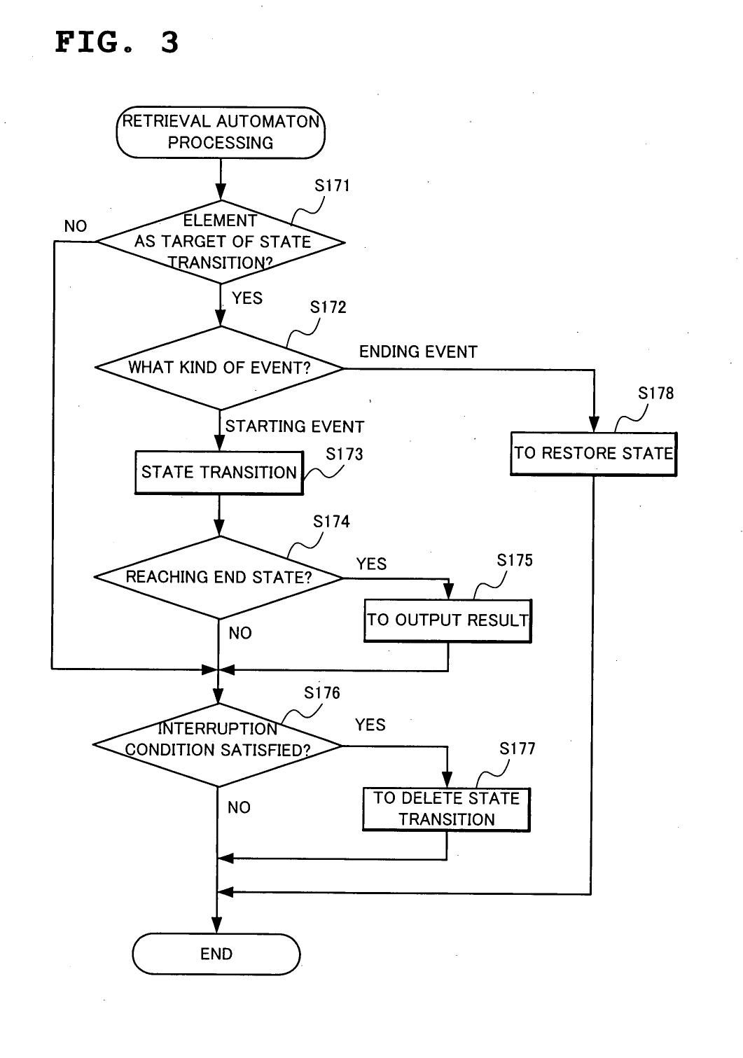

When accepting transfer of the analysis result of the structured document, the retrieval automaton management unit 140 executes retrieval automaton processing (Step S170). FIG. 3 is a flow chart showing processing executed at Step S170. The retrieval automaton management unit 140 checks whether an event of the transferred analysis result relates to an element as a target of a state transition or not and when it is not a target of a state transition, shifts to the processing at Step S176 and the following steps (Step S171). Subsequently, determine whether a kind of the event of the analysis result is an event indicative of the start of an element or an event indicative of the end of the element (Step S172) and when it is an event indicative of the end of the element, make a reverse transition of the state of the automaton 151 to a state as of before the transition and record the state in the storage device 150 (Step S178).

As a result of the processing of Step S172, when the determination is made that it is an event indicative of the start of an element, make a state transition according to the retrieval automaton 151 and when a subsequent state transition is deleted, restore the state and record a current state in the storage device 150 (Step S173). As a result of the state transition, when the state of the retrieval automaton 151 reaches the end state (Step S174), determine that it matches the retrieval expression to output the result (Step S175). Subsequently, when the interruption condition is satisfied (Step S176), delete a state transition matching the interruption condition from the retrieval automaton 151 and record the same in the storage device 150 (Step S177).

Upon completion of the retrieval automaton processing, the retrieval automaton management unit 140 checks whether an effective state transition remains in the retrieval automaton 151 (Step S180). When there remains an effective state transition, subsequently repeat the processing of Step S150 and Step S180. When there exists no effective state transition, instruct the structured document analysis unit 110 to end the analysis and end the retrieval.

Next, effects of the first exemplary embodiment will be described. The first exemplary embodiment is structured to obtain an interruption condition from structure information by the structure information analysis unit 130, so that the retrieval automaton management unit 140 deletes a relevant state transition when the interruption condition is satisfied and instructs on ending of analysis when there remains no effective state transition. As a result, structured document analysis processing can be reduced to mitigate load on retrieval processing.

Next, a second exemplary embodiment of the invention will be described in detail with reference to the drawings.

FIG. 4 is a block diagram showing an example of a structure of a structured document retrieval device 200 according to the second exemplary embodiment of the invention. In FIG. 4, components common to those of the structured document retrieval device 100 shown in FIG. 1 will be indicated by the same reference numerals to omit their detailed description.

As shown in FIG. 4, the structured document retrieval device 200 includes the structured document analysis unit 110, the retrieval expression analysis unit 120, a structure information analysis unit 230, a retrieval automaton management unit 240 and a storage device 250.

The structure information analysis unit 230, similarly to the structure information analysis unit 130 in the first exemplary embodiment, has a function of analyzing input structure information. While the structure information analysis unit 230 analyzes input structure information, it records an analysis result as structure information 252 in the storage device 250.

Although the retrieval automaton management unit 240 has the same function as that of the retrieval automaton management unit 140 in the first exemplary embodiment, it differs in obtaining necessary structure information from the structure information 252 recorded in the storage device 250. In addition to the information recorded by the storage device 150 in the first exemplary embodiment, the storage device 250 records the structure information 252.

Thus formed structured document retrieval device 200 of the second exemplary embodiment operates in the same manner as that of the structured document retrieval device 100 in the first exemplary embodiment. More specifically, when a retrieval expression is input, the retrieval expression analysis unit 120 analyzes an retrieval expression to transfer an analysis result to the retrieval automaton management unit 240 (see Step S110 in FIG. 2). When structure information is input, the structure information analysis unit 230 analyzes the structure information to transfer an analysis result to the retrieval automaton management unit 240 (Step S120). In the present exemplary embodiment, however, the structure information analysis unit 230 transfers the structure information also to the storage device 250. Upon receiving the retrieval expression analysis result, the retrieval automaton management unit 240 creates a retrieval automaton 151 and records the same in the storage device 250 (Step S130). In the present exemplary embodiment, however, the retrieval automaton management unit 240 receives input of a retrieval result of structure information from the storage device 250. When the structured document is input to the structured document analysis unit 110 (Step S140), the structured document analysis unit 110 analyzes the structured document to transfer an analysis result to the retrieval automaton management unit 240 (Step S150). Upon transfer of the analysis result of the structured document, the retrieval automaton management unit 240 executes retrieval automaton processing similarly to the first exemplary embodiment (Step S170).

Since the second exemplary embodiment is structured to record the structure information 252 in the storage device 250, it is unnecessary to input structure information at every input of a retrieval expression and enables reuse of the structure information 252 accumulated in the storage device 250.

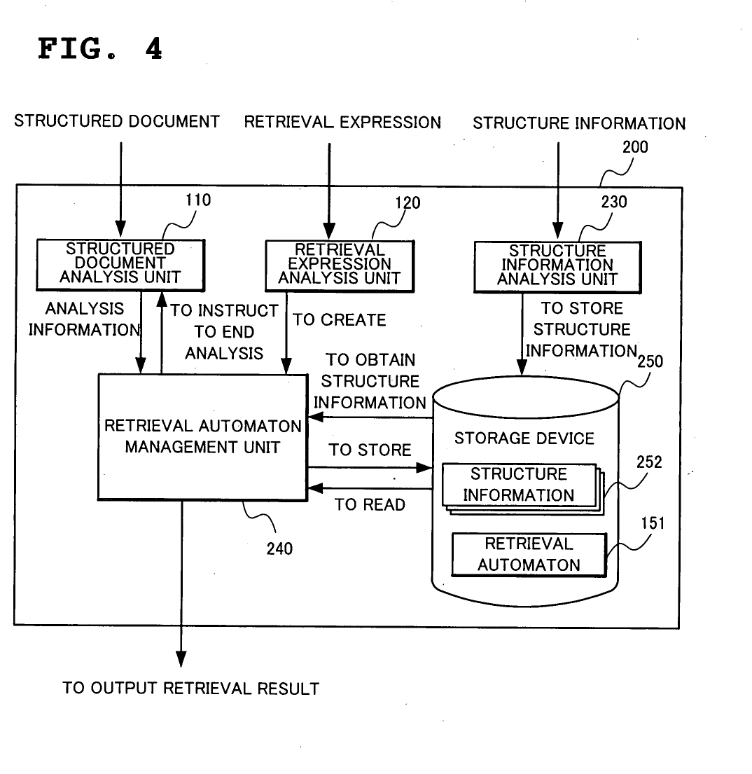

Although it is not described in particular in each of the above-described exemplary embodiments, various kinds of control processing at the structured document retrieval devices 100 and 200 are executed according to a structured document retrieval program 320 (see FIG. 5) which is for executing structured document retrieval processing.

FIG. 5 is a block diagram including the above-described structured document retrieval program 320 for executing structured document retrieval processing and a data processing device 330 operable according to the structured document processing program 320. Also illustrated in FIG. 5 are an input/output unit 310 and the storage device 150.

The data processing device 330, which internally has a central processing unit (CPU), is a control means shown in the lump as a part for executing various kinds of control processing (the structured document analysis unit 110, the retrieval expression analysis unit 120, the structure information analysis units 130, 230 and the retrieval automaton management units 140, 240) at the structured document retrieval devices 100 and 200 in the first and second exemplary embodiments. The structured document processing program 320, which is a control program for causing the data processing device 330 to execute the above-described various kinds of control processing, is mounted on the data processing device 330, for example.

The data processing device 330 writes information to the storage device 150 and reads information from the storage device 150 according to the structured document retrieval program 320, as well as executing various kinds of control in the first and second exemplary embodiment.

### EXAMPLE

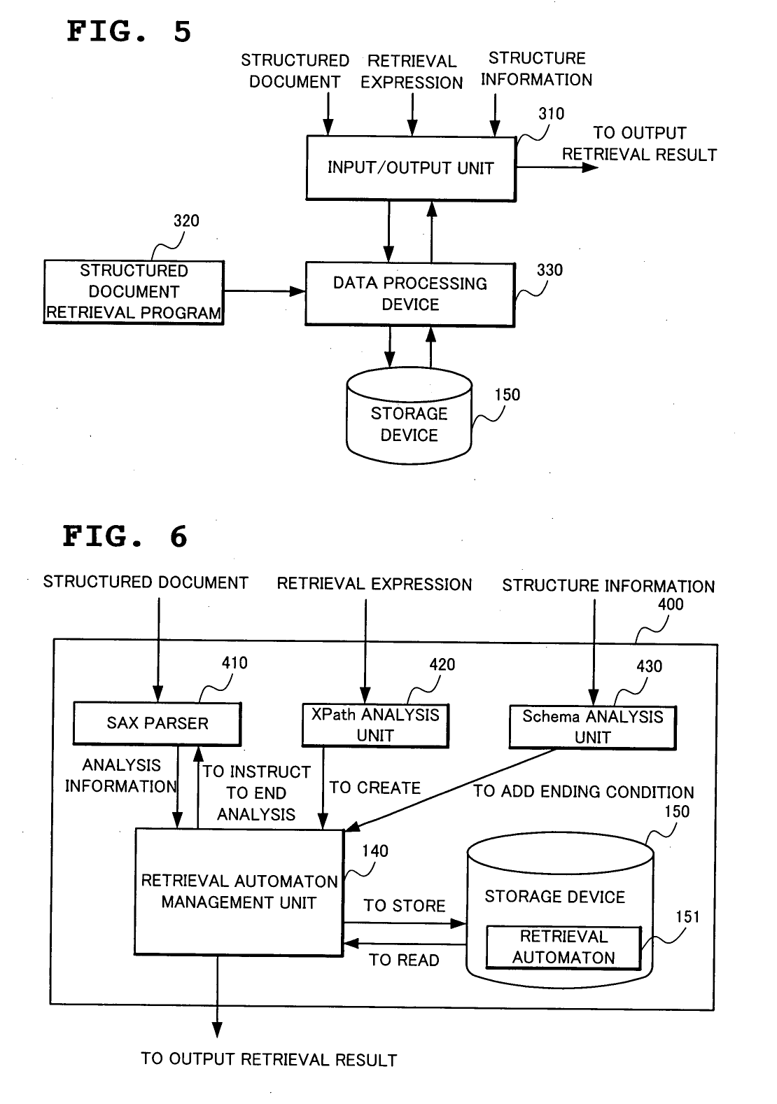

Next, a specific example of the present invention will be described. FIG. 6 is a block diagram showing a structured document retrieval device according to the example. The structured document retrieval device according to the example is an XPath retrieval device 400 which extracts a specific element described by retrieval expression XML Path language (XPath) from an XML document.

As shown in FIG. 6, the XPath retrieval device 400 comprises an SAX parser 410 as a structured document analysis unit, an XPath analysis unit 420 as a retrieval expression analysis unit and an XML Schema analysis unit 430 as a structure information analysis unit.

Assume here that the XPath expression 510 shown in FIG. 14 is input as a retrieval expression from a keyboard (not shown), for example. When the XPath expression 510 is input to the XPath analysis unit 420, an analysis result is transferred to the retrieval automaton management unit 140. Also assume in this example that XML Schema 520 shown in FIG. 7 is input as structure information from a hard disk (not shown), for example. In the XML Schema 520, information is recited that ┌a tag “a” occurs only once, the tag “a” includes tags “b” and “d” in this order and in the tag “b”, a tag “c” occurs only once┘. When the XML Schema 520 is input to the XML Schema analysis unit 430, an analysis result obtained by the XML Schema analysis unit 430 is transferred to the retrieval automaton management unit 140.

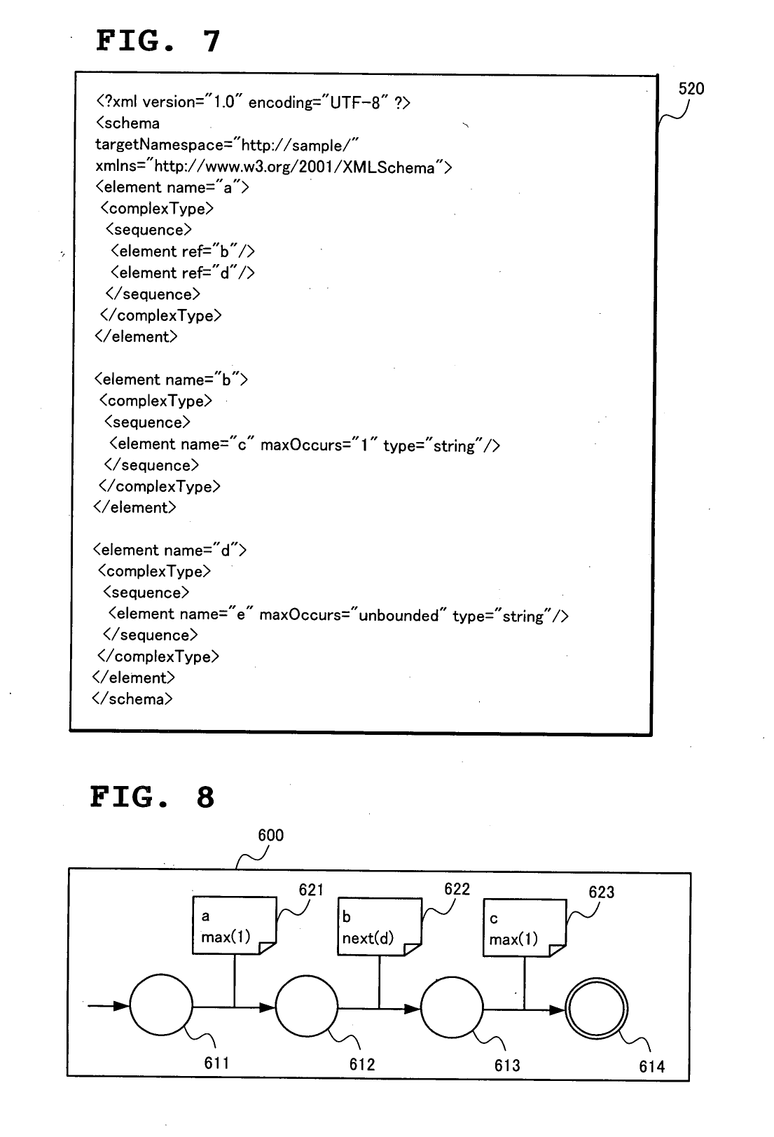

The retrieval automaton management unit 140 having received the analysis result of the XPath expression 510 and the analysis result of the structure information 520 creates a retrieval automaton 600 shown in FIG. 8. The retrieval automaton 600 has four states, states 611˜614 and state transitions between the states, 621˜623. The state 614 is an end state. Here, describing an interruption condition in the state transitions 621˜623 is a characteristic of the present invention. As an example, described as the interruption conditions are the maximum number max (1) of occurring state transitions (state transitions 621, 623) based on an analysis result of the structure information 520 and an element next (d) (state transition 622) subsequent to a state transiting element.

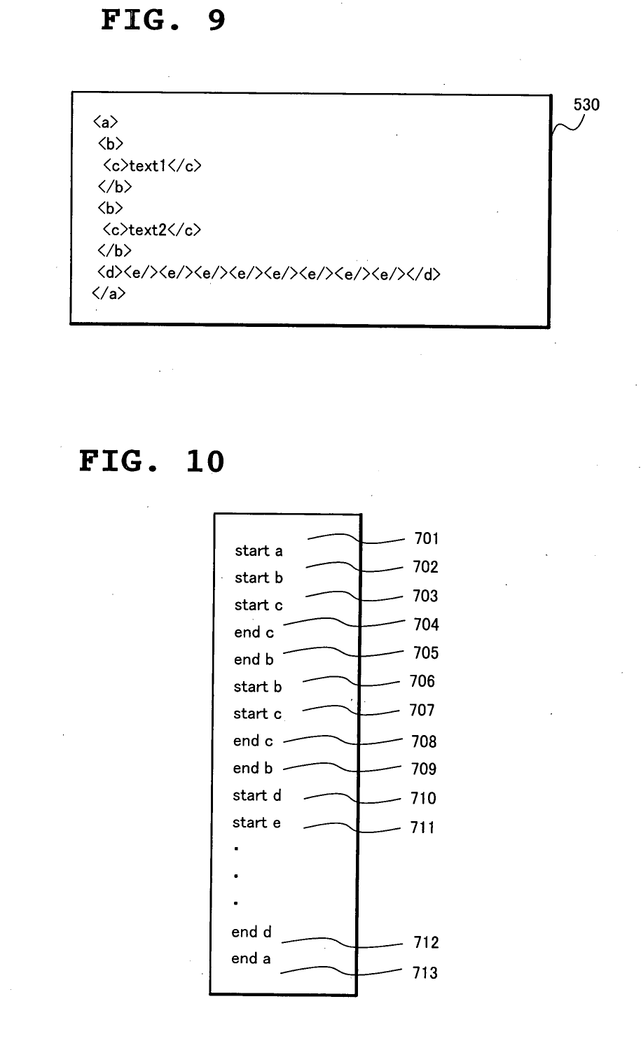

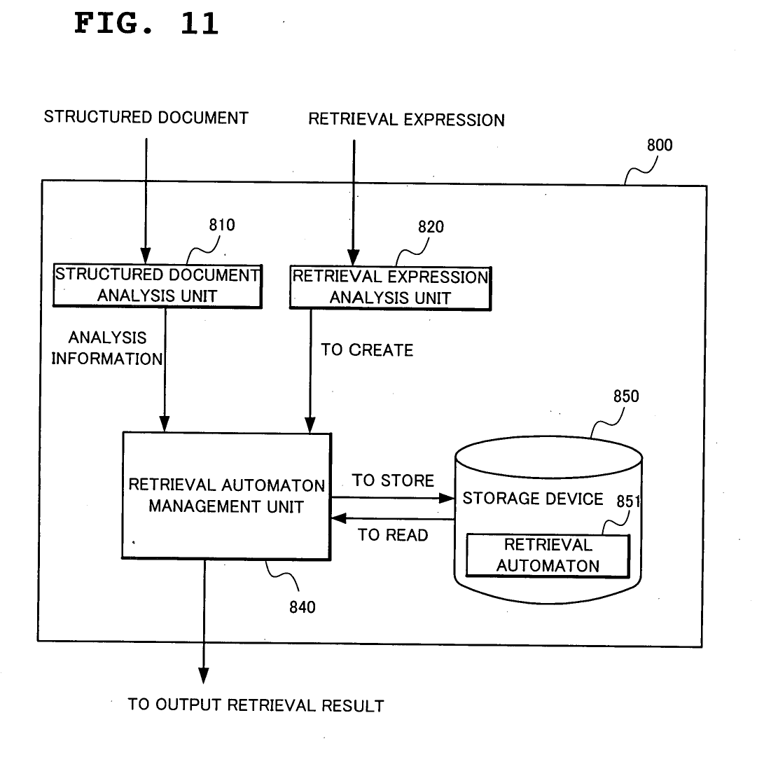

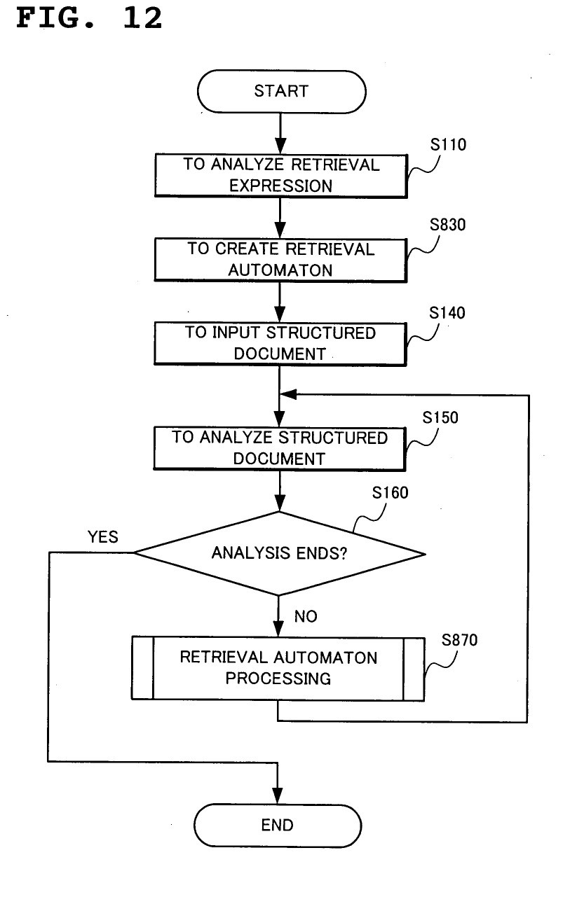

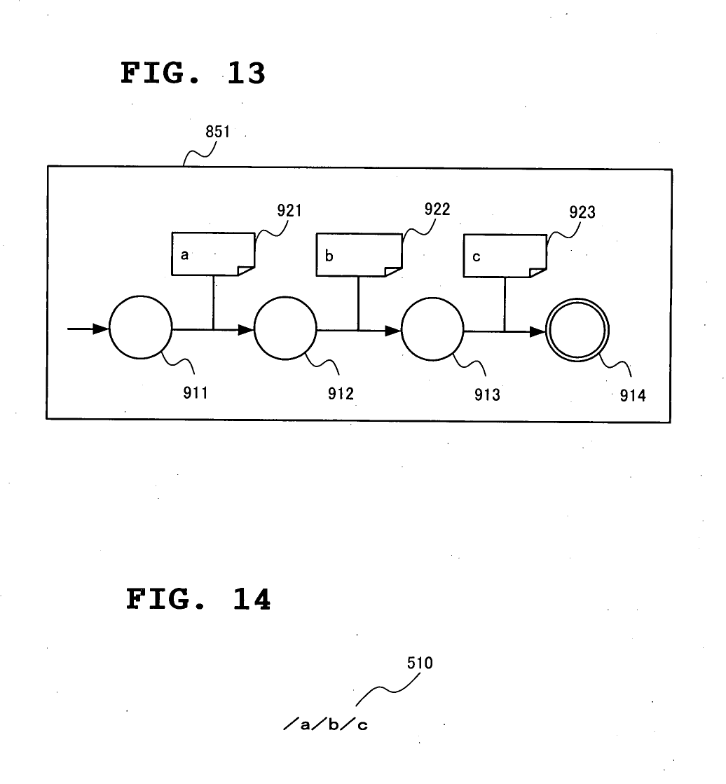

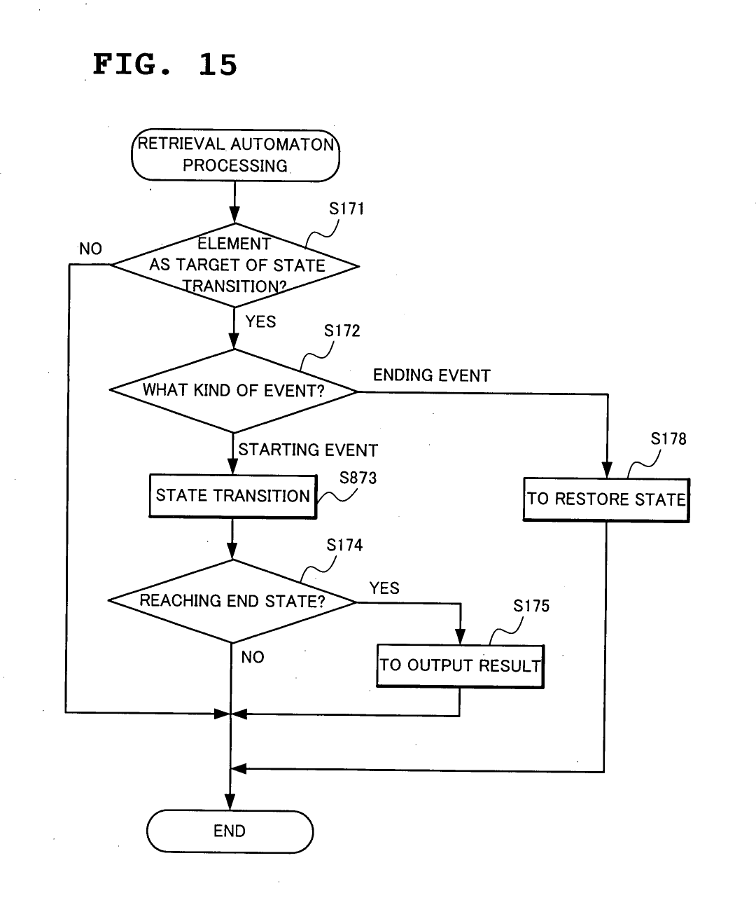

Further in this example, assume that an XML document 530 shown in FIG. 9 is input to the SAX parser 410 from a network interface, for example. FIG. 10 shows events occurring when the XML document 530 is analyzed to the end by the SAX parser 410. When events 701 to 703 are transferred from the SAX parser 410 to the retrieval automaton management unit 140, the retrieval automaton 600 initially at the state 611 sequentially makes a transition to the state 612, the state 613 and the state 614 to output a first result. At this time, the state transitions 621 and 623 are deleted because they meet in the interruption condition of the maximum number of occurrences. Subsequently, return to the state 612 by events 704 and 705. Furthermore, while making a transition to the state 613 by an event 706, the interruption condition of the state transition 623 is at this time returned to an initial value according to the processing of step S173 to restore the state transition. Furthermore, a second result is output by an event 707. A state transition remaining then is only the state transition 622. Return to the state 612 by events 708 and 709, so that the interruption condition of a subsequent element is satisfied by an event 710 to delete the state transition 622. Since as a result, there remains no effective state transition in the retrieval automaton 600, instruct the SAX parser 410 to interrupt to end the retrieval.

Operation in the foregoing manner requires execution of none of processing to be executed after the event 710 to enable load on retrieval to be mitigated.

The foregoing structure enables an element designated by a retrieval expression to be extracted with, neither overs nor shorts without analyzing a structured document to the end.

In addition, by adding a condition in which an element designated by a retrieval expression will fail to appear to the retrieval automaton and when the condition is satisfied, ending analysis, the element designated by the retrieval expression can be retrieved with neither overs nor shorts without analyzing a structured document to the end.

Moreover, by adding a condition in which an element designated by a retrieval expression will fail to appear to the retrieval automaton and when the condition is satisfied, ending analysis, determination can be made without analyzing a structured document to the end that the element designated by the retrieval expression will fail to appear.

The above-described structure enables extraction of elements designated by a retrieval expression with neither overs nor shorts without analyzing a structured document to the end.

The structured document retrieval device according to a third exemplary embodiment of the present invention is a structured document retrieval device (e.g. structured document processing devices 100 and 200, an XPath retrieval device 400) for extracting an element designated by a retrieval expression (e.g. XPath expression: XML Path Language expression) from a structured document (e.g. XML document), which is characterized in creating an interruption condition in which an element to be extracted will no more appear based on structure information (e.g. Step S130), sequentially analyzing a structured document by a structured document analysis unit (e.g. the structured document analysis unit 110, the SAX parser 410) (e.g. Step S150), retrieving an element matching the retrieval expression by a retrieval processing unit (e.g. the retrieval automaton management units 140, 240) and when all the interruption conditions are satisfied, interrupting the analysis of the structured document to end the retrieval (e.g. Step S180).

In addition, adding a condition in which an element designated by a retrieval expression will no more appear to a retrieval automaton and ending analysis when the condition is satisfied enables elements designated by the retrieval expression to be retrieved with neither overs nor shorts without analyzing a structured document to the end.

Moreover, adding a condition in which an element designated by a retrieval expression will no more appear to a retrieval automaton and ending analysis when the condition is satisfied enables determination that the element designated by the retrieval expression fails to appear without analyzing a structured document to the end.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INCORPORATION BY REFERENCE

This application is based upon and claims the benefit of priority from Japanese patent application No. 2005-017331, filed on Jan. 25, 2005, the disclosure of which is incorporated herein in its entirety by reference.

### INDUSTRIAL APPLICABILITY

The present invention is applicable for use in extracting specific information from an XML document. The present invention is also applicable to, for example, a router which extracts a specific element from an XML document flowing on a communication path to execute routing. Further applicable is for use as a communication relay device which executes various control on a communication path such as path control, logging, access control and message conversion. Still further applicable is for use as a processing device which determines a processing module according to an element extracted from such a structured document as an XML document arriving at a retrieval device.

1. A structured document retrieval device for extracting an element designated by a retrieval expression from a structured document, comprising:
a structured document analysis unit for sequentially analyzing said structured document, and
a structure information analysis unit for analyzing structure information and at a stage of confirming no more appearance of a target element, interrupting analysis of said structured document.

2. A structured document retrieval device for extracting an element designated by a retrieval expression from a structured document, comprising:
a structured document analysis unit for sequentially analyzing said structured document,
a retrieval expression analysis unit for inputting and analyzing a retrieval expression,
a structure information analysis unit for inputting and analyzing structure information, and
a retrieval processing unit for executing retrieval processing of said structured document, wherein
said retrieval processing unit
extracts an interruption condition for interrupting analysis of said structured document from said structure information analyzed by said structure information analysis unit,
sequentially inputs an analysis result from said structured document analysis unit, and
when said interruption condition is satisfied, instructs said structured document analysis unit to interrupt the analysis to end the retrieval.

3. The structured document retrieval device according to claim 2, wherein
said structure information includes either one or both of the maximum number of occurrences of an element and an element occurrence sequence, and
said retrieval processing unit extracts said interruption condition from either one or both of said information about the maximum number of occurrences of an element and the element occurrence sequence.

4. A structured document retrieval device for extracting an element designated by a retrieval expression from a structured document, comprising:
a structured document analysis unit for analyzing said structured document,
a retrieval expression analysis unit for inputting and analyzing a retrieval expression,
a structure information analysis unit for inputting and analyzing structure information, and
a retrieval automaton management unit, wherein
said retrieval automaton management unit
creates a retrieval automaton from said retrieval expression analyzed by said retrieval expression analysis unit and said structure information analyzed by said structure information analysis unit,
adds an interruption condition for interrupting a state transition based on said structure information to said retrieval automaton,
causes said retrieval automaton to make a state transition by structured document analysis information from said structured document analysis unit,
deletes a relevant state transition from said retrieval automaton when said interruption condition is satisfied, and
instructs said structured document analysis unit to interrupt the analysis to end the retrieval when there remains no effective state transition in said retrieval automaton.

5. The structured document retrieval device according to claim 4, wherein
the structure information analysis unit comprises a storage device and accumulates an analysis result of said structure information input in said storage device, and
said retrieval automaton management unit obtains an analysis result of said structure information accumulated from said storage device according to a retrieval expression transferred from said retrieval expression analysis unit.

6. The structured document retrieval device according to claim 4, wherein
said structure information includes either one or both of the maximum number of occurrences of an element and an element occurrence sequence, and
said retrieval automaton management unit generates said interruption condition from either one or both of said information about the maximum number of occurrences of an element and the element occurrence sequence.

7. The structured document retrieval device according to claim 1, wherein said structured document is an XML document.

8. The structured document retrieval device according to claim 1, wherein said retrieval expression is XPath.

9. The structured document retrieval device according to claim 1, wherein said structure information is XML schema.

10. A structured document retrieval method of extracting an element designated by a retrieval expression from a structured document, comprising:
inputting and analyzing a retrieval expression,
inputting and analyzing structure information,
extracting an interruption condition for interrupting analysis of said structured document from an analysis result of said structure information,
sequentially analyzing said structured document to retrieve said retrieval expression, and
when said interruption condition is satisfied, interrupting the analysis of said structured document to end the retrieval.

11. A structured document retrieval method of extracting an element designated by a retrieval expression from a structured document, comprising:
inputting and analyzing a retrieval expression,
inputting and analyzing structure information,
creating a retrieval automaton from an analysis result of the retrieval expression and an analysis result of the structure information,
adding an interruption condition for interrupting a state transition based on the analysis result of said structure information to said retrieval automaton,
sequentially analyzing said structured document,
causing said retrieval automaton to make a state transition by analysis information of said structured document,
deleting a relevant state transition from said retrieval automaton when said interruption condition is satisfied, and
interrupting the analysis of said structured document to end the retrieval when there remains no effective state transition.

12. The structured document retrieval method according to claim 10, comprising, with said structure information accumulated, determining necessary structure information from said retrieval expression input and using the information.

13. A structured document retrieval program for extracting an element designated by a retrieval expression from a structured document, which causes a computer to execute the steps of:
inputting and analyzing a retrieval expression,
creating a retrieval automaton from an analysis result of the retrieval expression and an analysis result of structure information,
adding an interruption condition for interrupting a state transition based on the structure information to the retrieval automaton,
causing the retrieval automaton to make a state transition by analysis information of said structured document,
deleting a relevant state transition when said interruption condition is satisfied, and
interrupting the analysis of said structured document to end the retrieval when there remains no effective state transition.

14. The structured document retrieval program according to claim 13, which causes the computer to execute the step of analyzing said structure information input to use the information for creating said retrieval automaton.

15. The structured document retrieval program according to claim 13, which causes the computer to execute the step of
accumulating said structure information, and
determining necessary structure information from said retrieval expression input and obtaining the information from said structure information accumulated.

16. The structured document retrieval device according to claim 5, wherein
said structure information includes either one or both of the maximum number of occurrences of an element and an element occurrence sequence, and
said retrieval automaton management unit generates said interruption condition from either one or both of said information about the maximum number of occurrences of an element and the element occurrence sequence.

17. The structured document retrieval method according to claim 11, comprising, with said structure information accumulated, determining necessary structure information from said retrieval expression input and using the information.
